(19) United States
(12) Patent Application Publication
(10) Pub. No.: US 2006/0030314 A1
(43) Pub. Date: Feb. 9, 2006

(54) Networked training and/or organization system

(76) Inventors: Janet Riehle, Cincinnati, OH (US); Timothy G. DeMarks, Cincinnati, OH (US); Susan C. Rutkowski, Loveland, OH (US); Jennifer Linnabary, Cincinnati, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 10/900,659

(22) Filed: Jul. 28, 2004

(51) Int. Cl. H04Q 7/20

(52) U.S. Cl. 455/432.3; 455/418; 455/414.1

(57) ABSTRACT

A networked training and/or organization system includes: (a) at least one central server operatively coupled to a user interface; and (b) a plurality of personal electronic assistant devices, where the personal electronic assistant devices include a display, an input device, memory, a data interface for establishing a data connection with the central server, and a control operatively coupled to the display, the input device, the memory and the data interface. The central server includes programming for performing the steps of: (i) establishing, via the user interface, organizational information personalized for each of at least two users of the personal electronic assistant devices; and (ii) uploading the personalized organizational information from the central server to the memory of the two respective personal electronic devices corresponding to the two users. The plurality of personal electronic devices include programming for performing the steps of: (i) downloading personalized organizational information from the central server to the memory of the respective personalized electronic device via the data interface of the respective personal electronic device; and (ii) communicating, using at least the display, the personalized organizational information to the user of the respective personal electronic device.

### BACKGROUND

The present invention is directed to tools and systems for assisting those with cognitive disabilities; and, more specifically, to a system that utilizes personal digital assistants (PDAs) that have been customized and individualized to assist people with cognitive disabilities, and especially, to assist in the performance of job functions or other every-day tasks.

People with significant cognitive disabilities have been among the population of people with disabilities that are least likely to be served by major advances in technology. Often, the support they need in activities of daily living, work, and community life involves low-tech, people-intensive support rather than emerging technology. High-tech products such as computer-assisted devices, Kurzweil software and other advances are actually for people with physical disabilities, but are often too advanced for a person with a cognitive disability. In many cases, people with cognitive and developmental disabilities require accommodations and adaptations that break a process down into its simplest functions such as counting boards, beeper alarms, reminder pagers, drawer separators, procedure picture books, etc.

PDAs have been adapted for use as communication devices and text readers for persons with visual impairments. However, they have not been as a cognitive prosthesis to enhance employment opportunities.

### SUMMARY

Exemplary embodiments of the present invention provide personal digital assistants (PDAs) whose functions are customized to assist users with cognitive disabilities in their day-to-day tasks and to also enhance employment opportunities. The customized software incorporates a broad range of standard programs that are known to be of use to people with cognitive disabilities and are easily adaptable for individualization. The customized PDAs are capable of being synchronized with a central server, over a wireless data connection for example, where administrators and other assistants and/or family members can modify or further customize the software modules and other data loaded on each of the individual's PDAs from time to time. Exemplary embodiments of the customized PDA devices include a calendar software module, a job book software module and a helpful hints software module. The calendar module provides simple-to-use calendar/task/reminder applications and the job book module delivers individualized job function instructions to the user through the PDA device.

Accordingly, it is the first aspect of the present invention to provide a networked training and/or organization system that includes: (a) at least one central server operatively coupled to a user interface (i.e., the user interface is directly coupled to the central server or operatively coupled over a data connection such as an internet connection, for example); and (b) a plurality of personal electronic assistant devices, where the personal electronic assistant devices include a display, an input device, memory, a data interface for establishing a data connection with the central server, and a control operatively coupled to the display, the input device, the memory and the data interface. The central server includes programming for performing the steps of: (i) establishing, via the user interface, organizational information personalized for each of at least two users of the personal electronic assistant devices; and (ii) uploading the personalized organizational information from the central server to the memory of the two respective personal electronic devices corresponding to the two users. The plurality of personal electronic devices include programming for performing the steps of: (i) downloading personalized organizational information from the central server to the memory of the respective personalized electronic device via the data interface of the respective personal electronic device; and (ii) communicating, using at least the display, the personalized organizational information to the user of the respective personal electronic device. In a more detailed embodiment, the central server further includes programming for performing the steps of: establishing, via the user interface, task information personalized for each of at least two users of the personal electronic assistant devices, and uploading the personalized task information from the central server to the memory of the two respective personal electronic devices corresponding to the two users; and the plurality of personal electronic devices including programming performing the steps of: downloading personalized task information from the central server to the memory of the respective personal electronic device via the data interface of the respective personal electronic device, and communicating, using at least the display, the personalized task information to the user of the respective personal electronic device. In yet a further detailed embodiment, access by the users to the central server programming is substantially restricted. Optionally, access to the central server programming is restricted to administrators and certain individuals having a position of authority over the at least two users.

The personalized task information may be communicated to the respective user by the corresponding personal electronic device in a series of steps. With such personal task information, the display may include a visual meter indicating the user's progress through the series of steps. It is also within the scope of the invention that each of the steps may display images pertaining to a corresponding step of the task using the display. The personal electronic devices may also include an audible actuator (such as a speaker) where at least some of the images are accompanied by audible instructions emitted through the audible actuator.

It is also within the scope of the first aspect of the present invention that the input device and the display of the personal electronic devices are combined as a touch screen display. It is also within the scope of the first aspect of the present invention that the data interface of the personal electronic devices is a wireless data interface. In such an embodiment, the personal electronic devices may include programming adapted to operatively connect the wireless data interface with the central server automatically on a pre-defined schedule.

It is also within the scope of the first aspect of the present invention that the programming on the central server is adapted to create a profile for each of the at least two users.

It is also within the scope of the first aspect of the present invention that the programming on the central server is adapted to establish, via the user interface, organizational information customized for subsets of the plurality of users of the personal electronic assistant devices.

It is also within the scope of the first aspect of the present invention that the programming on the central server is adapted to establish, via the user interface, task information customized for subsets of the plurality of users of the personal electronic assistant devices.

It is the second aspect of the present invention to provide a networked training and/or organization system that includes: (a) at least one central server operatively coupled to user interface; and (b) a plurality of personal electronic assistant devices, where the personal electronic assistant devices include a display, an input device, memory, a data interface for establishing a data connection with the central server, and a control operatively coupled to display the input device, the memory and the data interface. The central server includes programming for performing the steps of: (i) establishing, via the user interface, task information personalized for at least two users of the personal assistant devices; and (ii) uploading the personalized task information from the central server to the memory of the two respective personal electronic devices corresponding to the two users. The plurality of personal electronic devices include programming for performing the steps of: (i) downloading personalized task information from the central server to the memory of the respective personal electronic device via the data interface of the respective personal electronic device, and (ii) communicating, using at least the display, the personalized task information to the user of the respective personal electronic device. In a further detailed embodiment, access by the at least two users to the central server programming is substantially restricted. Optionally, access to the central server programming is restricted to administrators and certain individuals having a position of authority over the users.

It is within the scope of the second aspect of the present invention that the personalized task information is communicated to the respective user by the corresponding personal electronic device in a series of steps. In such a step, the display includes a visual meter indicating the user's progress through the series of steps. Furthermore, each of the steps may display images pertaining to a corresponding step of the task using the display. The personal electronic devices may also include an audible actuator (such as a speaker) where at least some of the images are accompanied by audible instructions emitted by the audible actuator.

It is also within the scope of the second aspect of the present invention that the input advice and the display of the personal electronic devices are combined as a touch screen display.

It is also within the scope of the second aspect of the present invention that the data interface of the personal electronic device is a wireless data interface. Such personal electronic devices may include programming adapted to operatively connect the wireless data interface with the central server automatically on a pre-defined schedule.

It is also within the scope of the invention that the programming on the central server is adapted to create a profile for each of the at least two users.

It is also within the scope of the second aspect of the present invention that the programming on the central server is adapted to establish, via the user interface, task information customized for subsets of the plurality of users of the personal electronic assistant devices.

### BRIEF DESCRIPTION OF THE DRAWINGS

FIG. 1 provides a front view of a hand-held device, in the form of personal digital assistant (PDA) customized for use with the present invention, where the display screen illustrates the main menu screen of the customized software;

FIG. 2 is a schematic system diagram according to an exemplary embodiment of the present invention;

FIG. 3 is a screen shot of the hand-held device illustrating a “job book” screen according to an exemplary embodiment of the present invention;

FIG. 4 is a screen shot of an alternate job book screen according to an exemplary embodiment of the present invention;

FIG. 5 is an alternate question-and-answer type job module screen according to an exemplary embodiment of the present invention;

FIG. 6 is a screen shot of the hand-held device illustrating the main “calendar” screen according to an exemplary embodiment of the present invention;

FIG. 7 is a screen shot of the hand-held device illustrating an individual's personal calendar for a given day according to an exemplary embodiment of the present invention;

FIG. 8 is a screen shot of the hand-held device illustrating an appointment request screen along with a map providing directions to the appointment;

FIG. 9 is a screen shot of a main user interface on a central server according to an exemplary embodiment of the present invention;

FIG. 10 is another screen the central server's interface illustrating an access rights menu of the central server's user interface; and

FIG. 11 is a screen shot of the central server's interface illustrating a mapping function.

### DETAILED DESCRIPTION

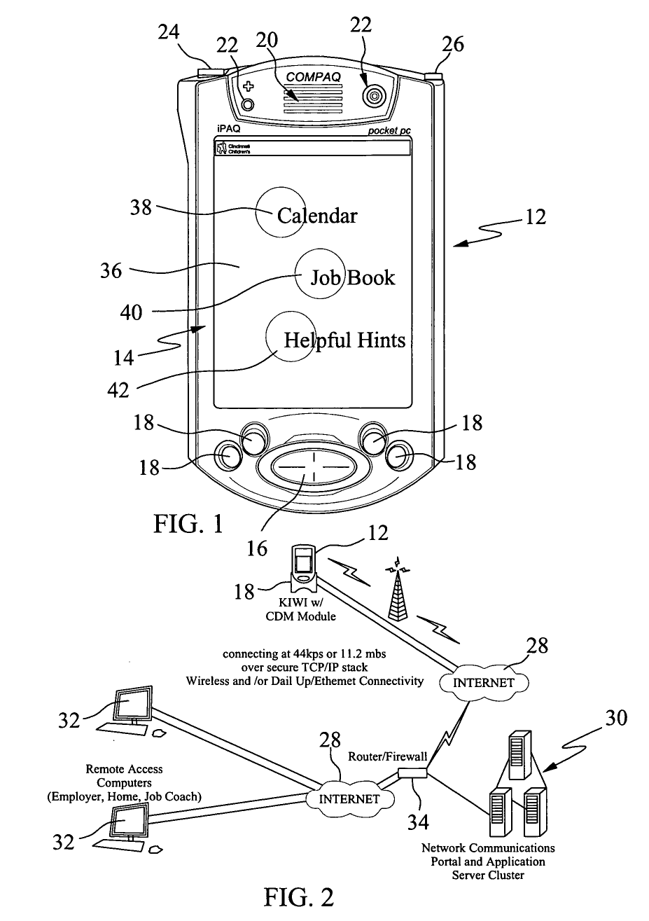

As shown in FIG. 1, a hand-held device 12, which is a customized personal digital assistant (PDA), is illustrated. In the exemplary embodiment, the hand-held device 12 is a Compaq® iPAQ® pocket PC device that has been customized to operate in the manner described herein. In the exemplary embodiment, the pocket PC may be customized in either one of two ways: (1) A program shell is loaded on the device that takes control of the PPC interface and prevents the user from accessing any other program application on the device. This shell is loaded into the backup restore command line so in the event the device's battery is discharged the shell will still initiate before the base operating system is accessible. Most importantly this shell is controlled through a password button entry so it may be bypassed by an administrator to access other applications and files on the device; or (2) a modified ROM may be used in place of the basic ROM loaded with the standard PPC applications and base operating system. This modified ROM would contain the base OS along with the networking and base program application files. Since the modified ROM is part of the PPC there is no need to modify the user interface and provide administrator access. The user would not be able to access other applications because they would have been deleted from the ROM prior to burning. Each of these customization processes will be readily known by one of ordinary skill in the art.

The hand-held device 12 includes a display screen 14, which is a “touch screen” interface in the exemplary embodiment. The hand-held device 12 also includes additional input mechanisms such as a control pad 16 and various control buttons 18. The hand-held device includes a data interface, which may be a wireless modem (not shown) or may be connector to a network cradle 18 (as shown in FIG. 2), or any other data interface as known to those of ordinary skill. The data interface will be used for communicating data between the hand-held device 12 and a central server 30 (as shown in FIG. 2). Referring back to FIG. 1, the hand-held device 12 also includes a speaker component 20, various LEDs 22, a power button 24 and an optional wireless modem antenna 26.

The hand-held device primarily has two software modules downloaded onto it: an employee assistance module (“job book”) and a lifestyle management calendar (“calendar”). Each of these modules can be customized by the central system server 30 for an individual user's particular disability and can also be customized for each individual user's job function, schedule and personal information. The job book is specifically configured to deliver individualized job function instructions to each person using their respective customized job book module. The hand-held device is also adapted to synchronize with a central server automatically for various module updates and calendar/task/reminder applications.

As shown in FIG. 2, the system includes a plurality of the hand-held devices 12 that are adapted to periodically couple to the Internet 28 for communication with a central server 30. The central server's applications for the present invention are also accessible over the Internet by remote access computers 32. Additionally, appropriate routers and firewalls 34 may also be utilized as desired for network security and efficiency. In the exemplary embodiment, the central server 30 relies on standards based operating systems along with standard database, storage, and communication software. In the exemplary embodiment, the modules downloaded to the various hand-held devices 12 and any other associated information may be monitored, customized, updated, and otherwise controlled by various authorized administrators using the remote access computers or by using a terminal directly coupled to or communicating with the central server 30. Such authorized administrators may include the user's employer, family member and/or job coach, for example. In the exemplary embodiment, the individual users are restricted from accessing most of the central server's operations as will be discussed in further detail below.

Of course, it will be appreciated by those of ordinary skill in the art that alternate data communication schemes and methods may be utilized to establish and effectuate communications both between the hand-held devices 12 and the central server 30 and between the remote access computers and the central server 30. Such alternate communication schemes and methods may include, but are not limited to, for example, dial-up network access via a standard internet connection, WiFi wireless connectivity including standards 802.11B and 802.11G, Bluetooth short range connectivity and Wide Area Network access utilizing CDPD, GPRS, 3G, and Edge wireless technologies.

Referring again to FIG. 1, the display screen 14 displays the main command screen 36, which includes three primary “buttons” actuatable using the touch screen and/or through manipulation of the input controls 16, 18. These three buttons include a calendar button 38 for activating the calendar module, a job book button 40 for activating the job book module and a helpful hints button 42. The calendar and job book modules will be described in detail below. The helpful hint button 42 brings up a screen that, in the exemplary embodiment, provides useful information for everyday purposes such as contact names and telephone numbers and other everyday-type reminders.

The job book module according to the exemplary embodiment of the present invention provides the user with a step-by-step guide for performing specific and detailed tasks of the individual's job or task. Each module can be customized to provide such automated guidance to account for the user's individual disabilities and/or tasks. As will be discussed below, alternate job modules may include a question-and-answer.

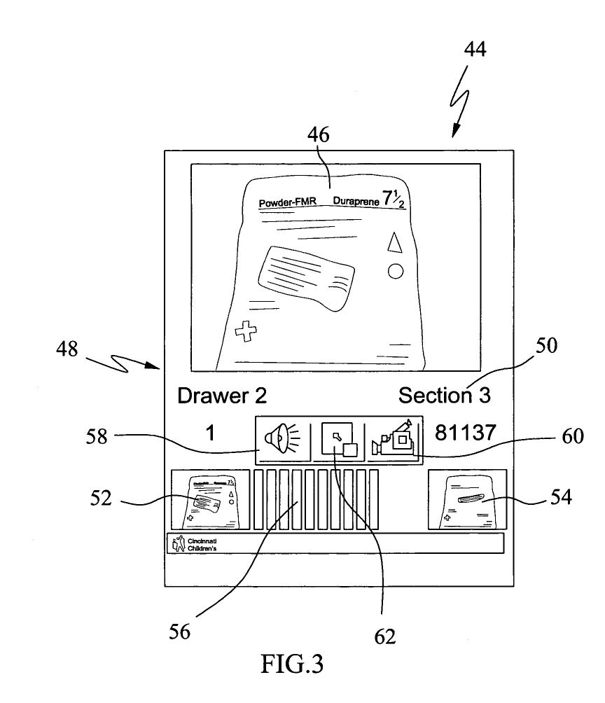

The job book module illustrated in the exemplary embodiment described herein is an automated picture-book task, describing to the user how to refill a medical supply cabinet in a hospital. As shown in FIG. 3, an example job book screen 44 for the hand-held device 12 is illustrated. This particular “page” provides a picture of the particular item 46 to be refilled in Drawer 248 of Section 350 of the medical cabinet. The screen also provides a picture 52, in its lower left hand corner, of the previous item that was refilled and also provides a picture of 54 in its lower right hand corner of the next item to be refilled. By activating the picture 46 of the present item, the hand-held device would fill the entire screen with a blow-up or a magnified view of the item. If the user were to activate the previous item picture 52, the hand-held device would move to the previous screen; and, likewise, if the user were to activate the next item picture 54, the job task would move to the next screen. The present screen 44 also provides a progress meter 56, which is a bar-graph that fills from left to right depending upon how far through the job steps the user is at the present step. In the present example, the progress of the present job is approximately 75% done.

The present screen also provides an audio button 58, a video button 60 and a zoom button 62. Upon activation of the audio button 58, the hand-held device would provide an audio description of the present item and/or the present step in the task. Upon activating the video button 60, the hand-held device would display a short video segment describing the present step in the task. Upon activating the zoom button 62, again the picture of the present item 46 would be zoomed to fill the entire screen.

This exemplary job task module is designed such that the user will progress through a plurality of these task screens until the entire supply cabinet has been filled and the task is complete. At that time, the progress meter 56 would indicate that the job is 100% complete. It is certainly within the scope of the invention that the audio and video components of the job task description could be automated within the progression through the particular job task module. For example, rather than showing a picture of the next item to be filled, it is within the scope of the invention that upon proceeding to a particular screen, a video of the next step in the task would be shown, and the task of providing merely a picture of the item to be filled could be an optional activation button. Likewise, it is within the scope of the invention that upon progressing to a next screen in the job task, that an audio description of the item and step could automatically be played. Certainly, it would be understood that numerous combinations and customizations can be provided for describing the various steps in a particular job task to an individual user. It is desired that such combinations and customizations will be customized with a particular user's cognitive disabilities and specific job tasks in mind. For example, if a user responds and understands video descriptions better than viewing picture representations of job task steps, then the job task steps could be customized to default to showing video representations of the particular job task steps. Since this is a networked application the ability to customize the user interface and application content is vast. For example, native language formatting may be used to provide audio instruction in the user's native language. Other accommodations may include virtual (avatar) assistants to act as a personal coach and provide a human element to the device and application interface.

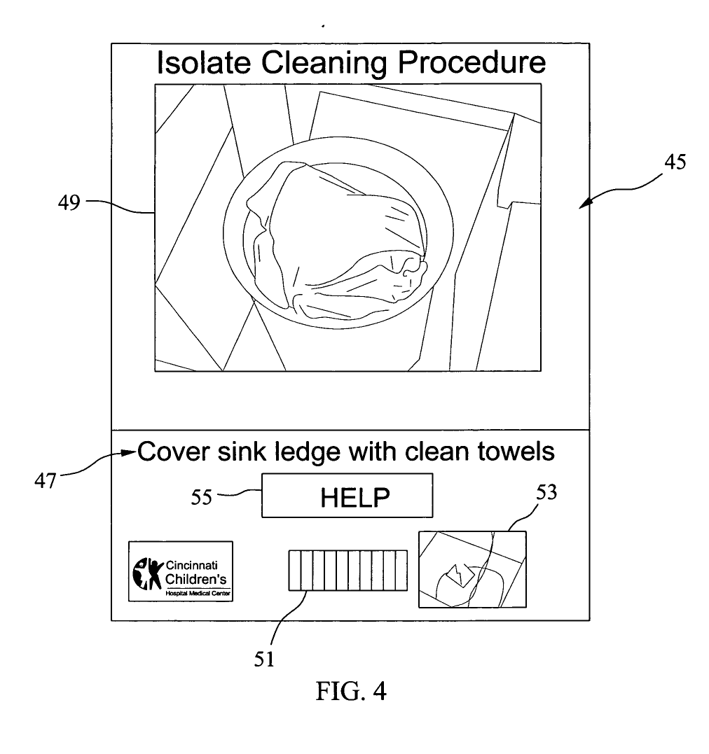

As shown in FIG. 4, an alternate job book module could provide step-by-step instructions for a chronological assembly, compilation, or construction type of job where the user is required to perform a series of steps in a specified order. In this screen shot 45, the user is given a step of the series in a text line 47, and is shown a corresponding photo 49 related to the step. This module also includes a progress meter 51, similar to the previous example job book module, and an actuatable picture 53 indicative of the next step in the process. There is also a help button 55 which can be actuated by the user to obtain more detailed instructions on the particular step or on the entire process. It is noted that with this example job book module, with the absence of audio or video cue buttons, the interface accommodates a higher functioning person, and instructions are provided for somebody who can read at a higher comprehension level.

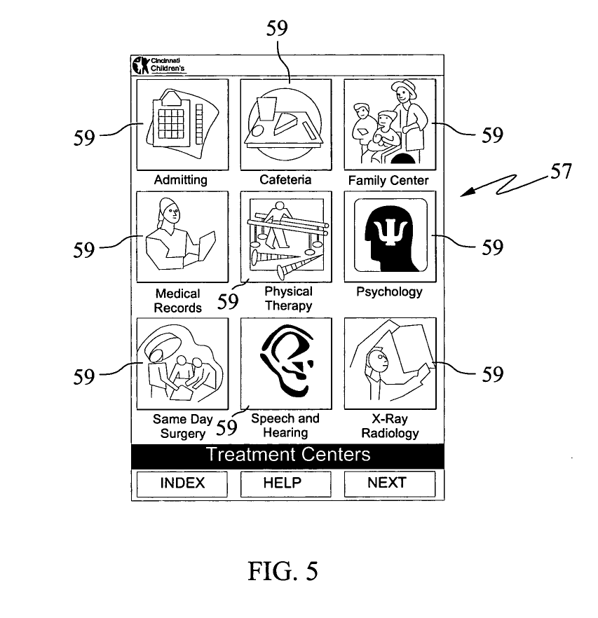

FIG. 5 provides a screen shot 57 of a question-and-answer type job module. This module provides visual accommodation and menu driven keys 59 for a question and answer job (i.e., reception desk). For example, if a customer/client asks the user for directions to the cafeteria, the user would activate the “Cafeteria” button 59 and the device would instantly bring up written directions for the cafeteria. The accommodation for this job could also include an audio clip and/or video clip that plays recorded directions so the user could give them to the customer/client making the request.

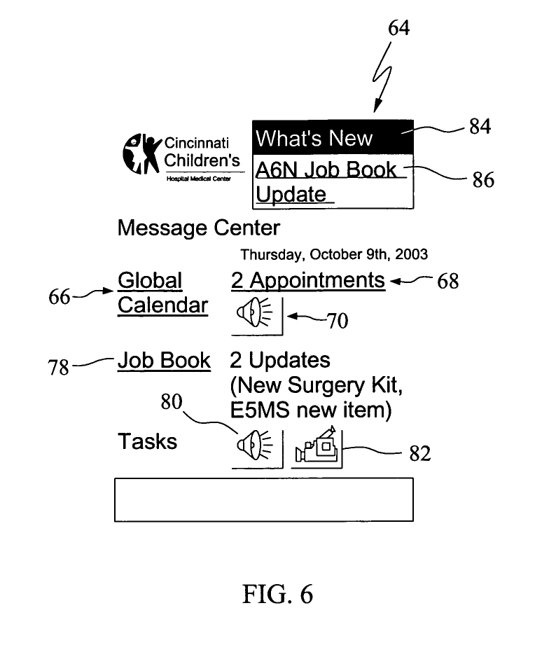

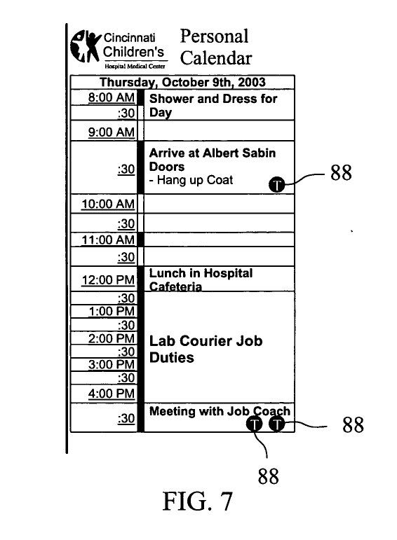

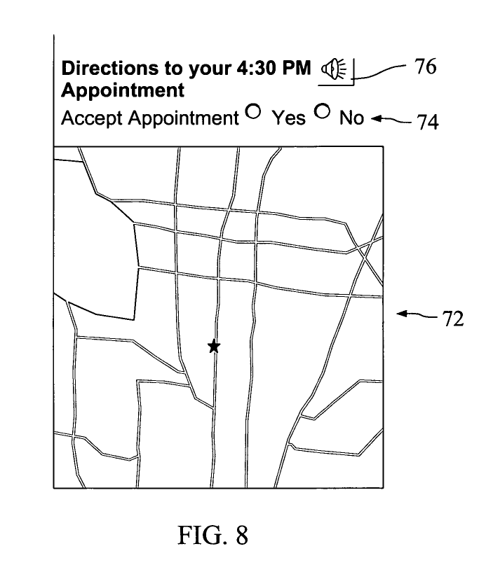

FIG. 6 provides a screen shot 64 of the primary calendar screen that will be provided when the user activates the calendar button 38 on the main display (as shown in FIG. 1). The main calendar screen provides several links and activation buttons that the user can activate using the touch screen display or using the activation pads or buttons 16, 18. The global calendar link 66 brings up a calendar page as shown, for example, in FIG. 7, which graphically illustrates the individual's personal calendar for that day. This personal calendar screen will be described in further detail below. Along with the global calendar link 66, is an appointment link 68 and an associated appointment audio button 70. By activating the appointment link 68, the hand-held device will display the two appointments that have been scheduled for the individual, and which may require acceptance. For example, as shown in FIG. 8, by clicking the appointment link 68, a screen can be provided which shows a map 72 to the user's appointment and a field 74 in which the user can accept or not accept a particular appointment. The screen also includes an audio button 76 which, upon activation, will provide the user with audio instructions regarding the appointment.

Referring back to FIG. 6, upon activating the audio button 70 associated with the appointments, the hand-held device will provide audio instructions or options regarding the appointments that have been scheduled. These audio instructions may also be given along with a visual display such as shown in FIG. 8. The primary calendar screen 64 also provides a job book link 78, which, upon activation, will cause the hand-held device to activate the user's job book as described above. Note that this field also includes indication that two updates have been added to his or her job book.

The tasks section includes an audio button 80 and a video button 82 which can provide audio and video reminders, respectively, of various tasks that the individual needs to perform at various times of the day.

Finally, a ‘What's New’ window 84 can be used to provide the individual with news on updates to his or her job tasks, appointments, day-to-day tasks and events, and the like. In the present example, the ‘What's New’ window 84 has a link 86 which will take the user to the job book indicating the newest updates that have been downloaded to the job book.

Referring again to FIG. 7, which illustrates a personal calendar for a user's given day, it is noted that several of the appointments include task buttons 88 which may be activated by the user. These task buttons can be multi-media links such as directions for performing the particular day-to-day tasks set forth in the schedule, maps to an appointment, audio instructions on where to go and the like. Furthermore, as discussed herein, the calendar functions are networked so that other authorized users/administrators can view, modify, or create entries that are then pulled to the device 12.

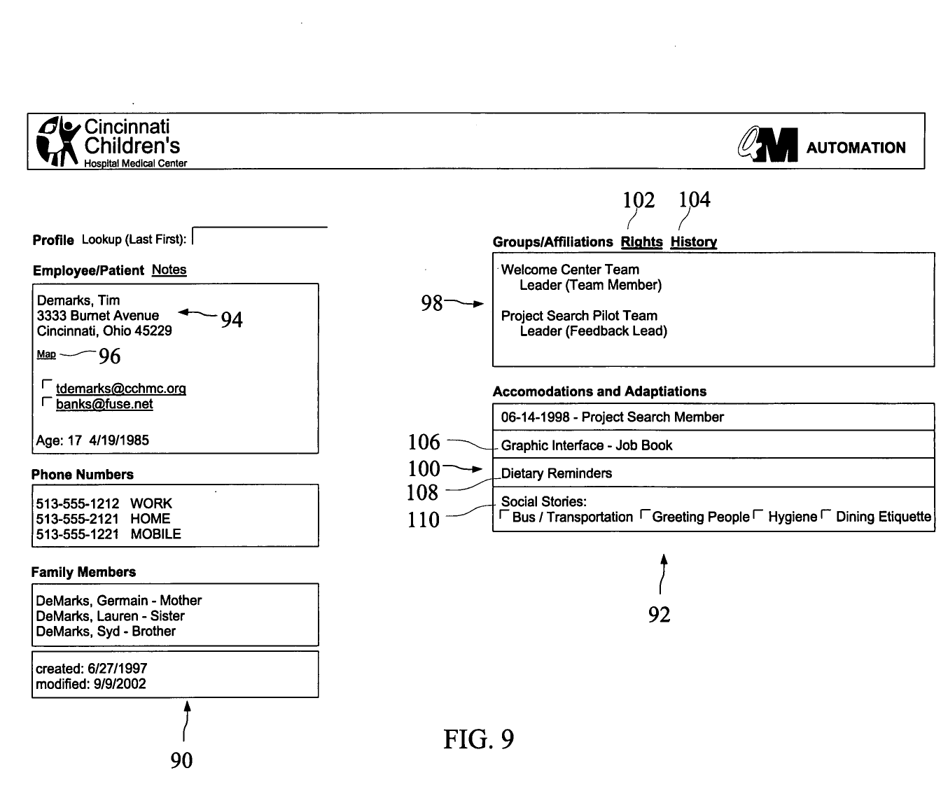

As discussed above in reference to FIG. 2, the networked system allows operation of the job modules and calendar modules on every individual's hand-held device 12 to be customized for each individual by authorized administrators interfacing with a central system server 30. These authorized administrators may access the central system server 30 over the Internet 28 using remote access computers 32 or may access the central system server 30 at the central system server's premises. FIG. 9 provides an example interface screen for a particular user/employee (user of a hand-held device) which may be accessible by one of the authorized administrators. The interface is primarily divided into an employee profile area on the left side 90 which remains substantially static throughout the various stages of the interface and a variable area 92 on the right side which is essentially a “working area.” The employee profile area includes information on the particular employee 94, a link 96 to a map of where the employee resides or works so that a job coach, for example, can find the person physically, if necessary. In future embodiments, this map can also interface to a GPS tracking unit carried by the user so that the job coach or other authorized administrator could be able to locate the individual on a map using the GPS service. The two working areas shown on the variable portion 92 include a Group/Affiliations working area 98 and an Accommodation/Adaptations area 100. The Group/Affiliations area provides a listing of the various groups that the individual employee is assigned, belongs, or is employed under. This allows the authorized administrators to customize functions of individuals' software modules on a group-wide basis and also allows the authorized administrators to provide information or communicate to the individuals on group-wide bases. The “Rights” link 102 will bring up a working area that allows the authorized administrator to modify the access rights for these Groups/Affiliations and the “History” link 104 will allow an authorized administrator to view a history of the individual's jobs or affiliations.

The Accommodations and Adaptations working area 100 provides the authorized administrator to set up the type of graphic interface for the individual's hand-held device. For example, as shown in the present screen, the graphic interface 106 set up for the present individual is the “job book” interface. Other available interfaces include a question/answer type of interface which allows the user to answer simple questions by way of providing map and audio to the user such as “where is the restroom?” Another selectable interface is a hybrid interface that is a combination of both a job book and a question/answer interface. There is also a field in the Accommodations/Adaptations work area that indicates whether the user has any special reminders or tasks such as, in the present case, “dietary reminders.” Finally, an active area 110 provides the ability for the authorized administrator to activate various social stories that can be downloaded to the user's hand-held device for providing audio and video “helpful hints” for the individual.

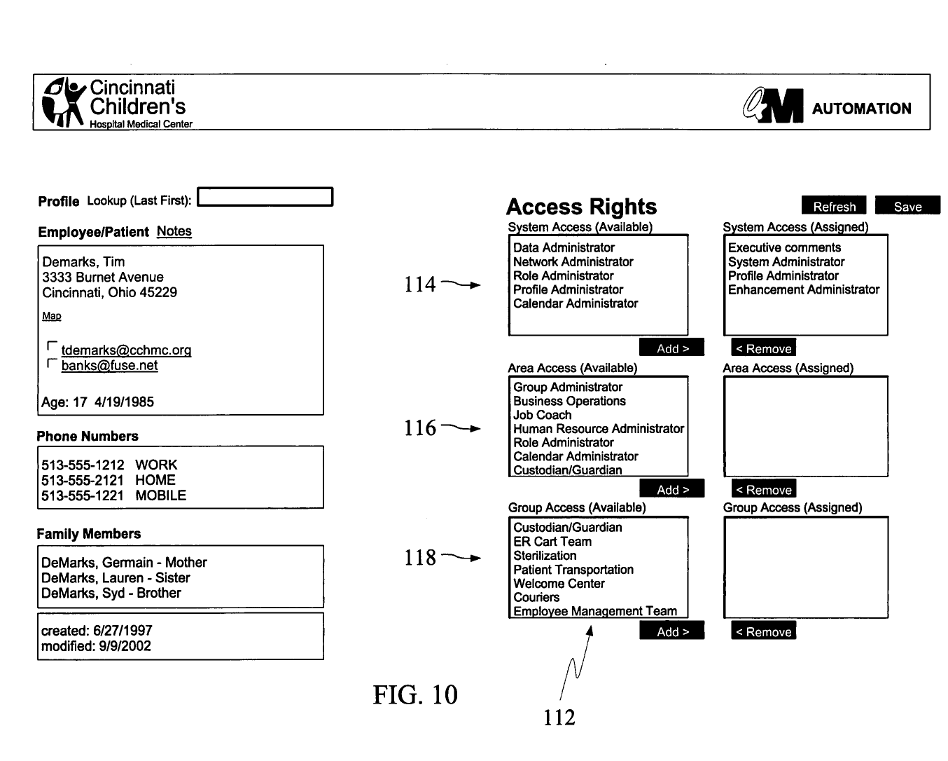

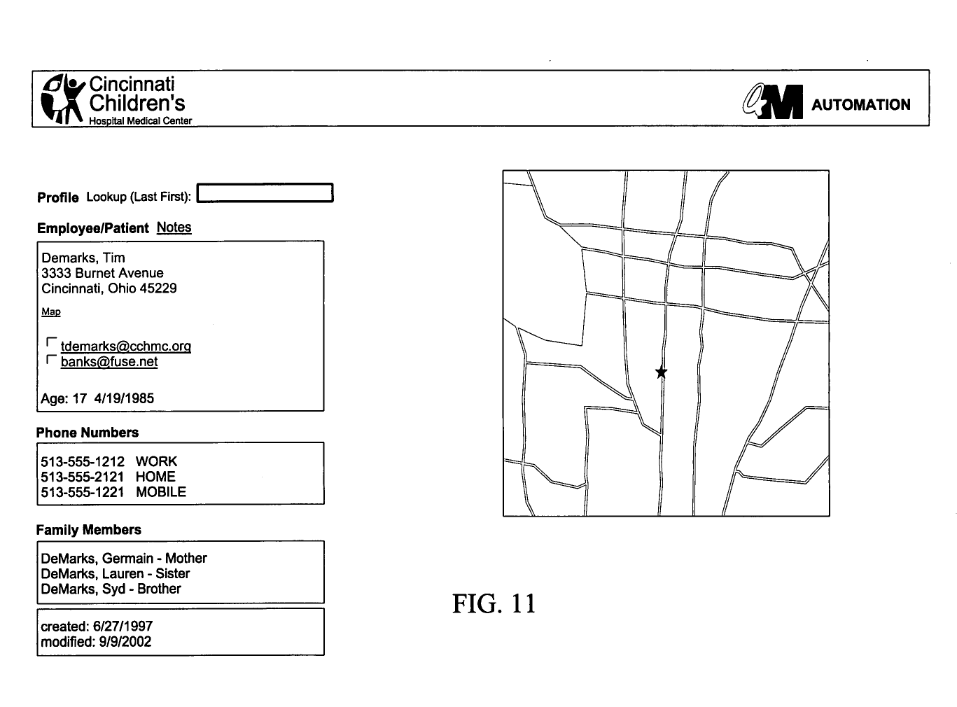

FIG. 10 provides an example of a work area 112 in which the various access rights to the present administration software can be set up and customized for various individuals (such as other authorized administrators or users). “System” access rights 114 are access rights that provide full access to all data levels and access to every module. Authorized administrators with such full access rights can create, edit and delete information. “Area” access rights 116 have more limited access rights and cannot make system level changes, i.e., cannot create a new file and can only change and add information in various areas. “Group” access rights only provide the authorized administrator to view information and assign group classifications. For example, such Group access rights allow such an authorized administrator to send information and messages to the various groups he or she is assigned. As discussed above, such groups are assigned when setting up a profile for an individual user.

Following from the above description and invention summaries, it should be apparent to those of ordinary skill in the art that, while the apparatuses and processes herein described constitute exemplary embodiments of the present invention, it is to be understood that the invention is not limited to these precise apparatuses and processes and that changes may be made therein without departing from the scope of the invention as defined by the claims. Additionally, it is to be understood that the invention is defined by the claims and it is not intended that any limitations or elements describing the exemplary embodiments set forth herein are to be incorporated into the meaning of the claims unless such limitations or elements or explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A networked training and/or organization system comprising:
at least one central server operatively coupled to a user interface; and
a plurality of personal electronic assistant devices, the personal electronic assistant devices including a display, an input device, memory, a data interface for establishing a data connection with the central server, and a control operatively coupled to the display, the input device, the memory and the data interface;
the central server including programming for performing the steps of,
establishing, via the user interface, organizational information personalized for each of at least two users of the personal electronic assistant devices; and
uploading the personalized organizational information from the central server to the memory of the two respective personal electronic devices corresponding to the two users; and
the plurality of personal electronic devices including programming for performing the steps of,
downloading personalized organizational information from the central server to the memory of the respective personal electronic device via the data interface of the respective personal electronic device, and
communicating using at least the display the personalized organizational information to the user of the respective personal electronic device.

2. The networked training and/or organization system of claim 1, wherein:
the central server further includes programming for performing the steps of,
establishing, via the user interface, task information personalized for each of at least two users of the personal electronic assistant devices; and
uploading the personalized task information from the central server to the memory of the two respective personal electronic devices corresponding to the two users; and
the plurality of personal electronic devices including programming for performing the steps of,
downloading personalized task information from the central server to the memory of the respective personal electronic device via the data interface of the respective personal electronic device, and
communicating using at least the display the personalized task information to the user of the respective personal electronic device.

3. The networked training and/or organization system of claim 2, wherein access by the at least two users to the central server programming is substantially restricted.

4. The networked training and/or organization system of claim 2, wherein access to the central server programming is restricted to administrators and certain individuals having a position of authority over the at least two users.

5. The networked training and/or organization system of claim 2, wherein the personalized task information is communicated to the respective user by the corresponding personal electronic device in a series of steps.

6. The networked training and/or organization system of claim 5, wherein the display includes a visual meter indicating the user's progress through the series of steps.

7. The networked training and/or organization system of claim 5, wherein each of the steps display images pertaining to a corresponding step of the task using the display.

8. The networked training and/or organization system of claim 7, wherein the personal electronic devices include at least one audible actuator (i.e., speaker) and at least some of the images are accompanied by audible instructions emitted by the audible actuator.

9. The networked training and/or organization system of claim 8, wherein the images are automated, at least in part.

10. The networked training and/or organization system of claim 1, wherein the input device and the display of the personal electronic devices are combined as a touch screen display.

11. The networked training and/or organization system of claim 1, wherein the data interface of the personal electronic devices is a wireless data interface.

12. The networked training and/or organization system of claim 11, wherein the personal electronic devices include programming adapted to operatively connect the wireless data interface with the central server automatically on a predefined schedule.

13. The networked training and/or organization system of claim 1, wherein the programming on the central server is adapted to create a profile for each of the at least two users.

14. The networked training and/or organization system of claim 1, wherein:
the programming on the central server is adapted to establish, via the user interface, organizational information customized for subsets of the plurality of users of the personal electronic assistant devices.

15. The networked training and/or organization system of claim 1, wherein:
the programming on the central server is adapted to establish, via the user interface, task information customized for subsets of the plurality of users of the personal electronic assistant devices.

16. The networked training and/or organization system of claim 1, wherein the user interface operatively coupled to the central server is a remote computer operatively coupled to the central server over a global computer network.

17. A networked training and/or organization system comprising:
at least one central server operatively coupled to a user interface; and
a plurality of personal electronic assistant devices, the personal electronic assistant devices including a display, an input device, memory, a data interface for establishing a data connection with the central server, and a control operatively coupled to the display, the input device, the memory and the data interface;
the central server including programming for performing the steps of,
establishing, via the user interface, task information personalized for each of at least two users of the personal electronic assistant devices; and
uploading the personalized task information from the central server to the memory of the two respective personal electronic devices corresponding to the two users; and
the plurality of personal electronic devices including programming for performing the steps of,
downloading personalized task information from the central server to the memory of the respective personal electronic device via the data interface of the respective personal electronic device, and
communicating using at least the display the personalized task information to the user of the respective personal electronic device.

18. The networked training and/or organization system of claim 17, wherein access by the at least two users to the central server programming is substantially restricted.

19. The networked training and/or organization system of claim 17, wherein access to the central server programming is restricted to administrators and certain individuals having a position of authority over the at least two users.

20. The networked training and/or organization system of claim 17, wherein the personalized task information is communicated to the respective user by the corresponding personal electronic device in a series of steps.

21. The networked training and/or organization system of claim 20, wherein the display includes a visual meter indicating the user's progress through the series of steps.

22. The networked training and/or organization system of claim 20, wherein each of the steps display images pertaining to a corresponding step of the task using the display.

23. The networked training and/or organization system of claim 22, wherein the personal electronic devices include at least one audible actuator (i.e., speaker) and at least some of the images are accompanied by audible instructions emitted by the audible actuator.

24. The networked training and/or organization system of claim 23, wherein the images are automated, at least in part.

25. The networked training and/or organization system of claim 17, wherein the input device and the display of the personal electronic devices are combined as a touch screen display.

26. The networked training and/or organization system of claim 17, wherein the data interface of the personal electronic devices is a wireless data interface.

27. The networked training and/or organization system of claim 26, wherein the personal electronic devices include programming adapted to operatively connect the wireless data interface with the central server automatically on a predefined schedule.

28. The networked training and/or organization system of claim 17, wherein the programming on the central server is adapted to create a profile for each of the at least two users.

29. The networked training and/or organization system of claim 17, wherein:
the programming on the central server is adapted to establish, via the user interface, task information customized for subsets of the plurality of users of the personal electronic assistant devices.

30. The networked training and/or organization system of claim 16, wherein the user interface operatively coupled to the central server is a remote computer operatively coupled to the central server over a global computer network.
